(19) United States
(12) Patent Application Publication
(10) Pub. No.: US 2006/0158582 A1
(43) Pub. Date: Jul. 20, 2006

(54) Color filter array in CMOS image sensor

(75) Inventor: Joon Hwang, Chungcheongbuk-do (KR)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: DongbuAnam Semiconductor Inc.

(21) Appl. No.: 11/320,681

(22) Filed: Dec. 30, 2005

(30) Foreign Application Priority Data
Dec. 30, 2004 (KR) 10-2004-0117233

(51) Int. Cl. G02F 1/1347

(52) U.S. Cl. 349/80

(57) ABSTRACT

An exemplary color filter array in a CMOS image sensor according to an embodiment of the present invention includes a blue pixel and a red pixel that are larger than a green pixel. Accordingly, the photosensitivity of the green, the red, and the blue pixel may be same, so reproducibility of the colors can be enhanced.

### CROSS-REFERENCE TO RELATED APPLICATION

This application claims priority to and the benefit of Korean Patent Application No. 10-2004-0117233 filed in the Korean Intellectual Property Office on Dec. 30, 2004, the entire contents of which are incorporated herein by reference.

### BACKGROUND OF THE INVENTION

(a) Field of the Invention

The present invention relates to a color filter array in a CMOS image sensor. More particularly, the present invention relates to an arrangement of a color filter array in a method of manufacturing a CMOS image sensor.

(b) Description of the Related Art

Image sensors that convert optical images into electrical signals are classified as a charge coupled device (CCD) and a complementary MOS (CMOS) image sensor. A CCD is operated by storing charge carriers in a respective MOS capacitor and transferring the charge carriers to a neighboring MOS capacitor. A CMOS image sensor having MOS transistors of as many as there are pixels adopts a switching method wherein an output signal is processed by using a control circuit and a signal processing circuit.

A CMOS image sensor for converting the information of an object into electrical signals includes signal-processing chips having photodiodes therein. Each signal-processing chip may have an amplifier, an analogue/digital (A/D) converter, an internal voltage generator, a timing generator, and a digital logic device. This signal-processing chip has merits such as a smaller volume, a lower power consumption, and a cost reduction. Although a CCD is manufactured by a unique process, a CMOS image sensor can be manufactured by a typical silicon process for integrated circuits (IC). Therefore, the CMOS image sensor can be mass produced and highly integrated.

In a CMOS image sensor, incident light is divided into blue, red, and green colors. The blue color having a short wavelength and the red color having a long wavelength have a drawback in that their photosensitivities are lower than that of the green color. Accordingly, if the photosensitivities are not uniformly controlled, the reproducibility of the color may be deteriorated.

A conventional color filter array in a CMOS image sensor will hereinafter be described in detail with reference to the accompanying FIG. 1.

FIG. 1 is a drawing showing a conventional color filter array in a CMOS image sensor.

In a typical bayer pattern that is widely used, a blue pixel 10, a green pixel 11, and a red pixel 12 of the same size are arrayed. There are two green pixels 11, because the color of a reflection image is mainly green.

FIG. 2 is a graph showing a photosensitivity difference between each pixel.

The x-axis of the graph denotes the light quantity, and the y-axis denotes the output signal. A higher slope indicates the higher photosensitivity. Generally, the photosensitivity of the green color is the highest, and that of the blue color is the lowest. Such a photosensitivity difference causes a poor reproducibility of the colors.

As described above, the conventional color filter array in a CMOS image sensor has a drawback.

That is, in the CMOS image sensor wherein the photosensitivity of the green color is the highest and photosensitivity of the blue color is the lowest, the detecting regions of blue, red, green light of the same size cause poor reproducibility of the colors.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a color filter array in a CMOS image sensor having advantages of enhancing image quality of the CMOS image sensor by controlling photosensitivity.

An exemplary color filter array in a CMOS image sensor according to an embodiment of the present invention includes a blue pixel and a red pixel that are larger than a green pixel. The color filter array may be composed in a bayer pattern.

In a further embodiment, the size of the red pixel and that of the blue pixel may depend on a photosensitivity difference from the green pixel. The size of the red pixel may be larger than that of the green pixel by 5-30%, and the size of the blue pixel may be larger than that of the green pixel by 5-40%.

In addition, the size of the blue pixel may be larger than the size of the red pixel.

In a further embodiment, the size of the blue pixel may depend on a photosensitivity difference between the blue pixel and the red pixel. The size of the blue pixel may be larger than that of the red pixel by 5-20%.

### BRIEF DESCRIPTION OF THE DRAWINGS

FIG. 1 is a drawing showing a conventional color filter array in a CMOS image sensor.

FIG. 2 is a graph showing a photosensitivity difference between each pixel.

FIG. 3 is a drawing showing a color filter array in a CMOS image sensor according to an exemplary embodiment of the present invention.

FIG. 4 is a graph showing a photosensitivity of each pixel according to an exemplary embodiment of the present invention.

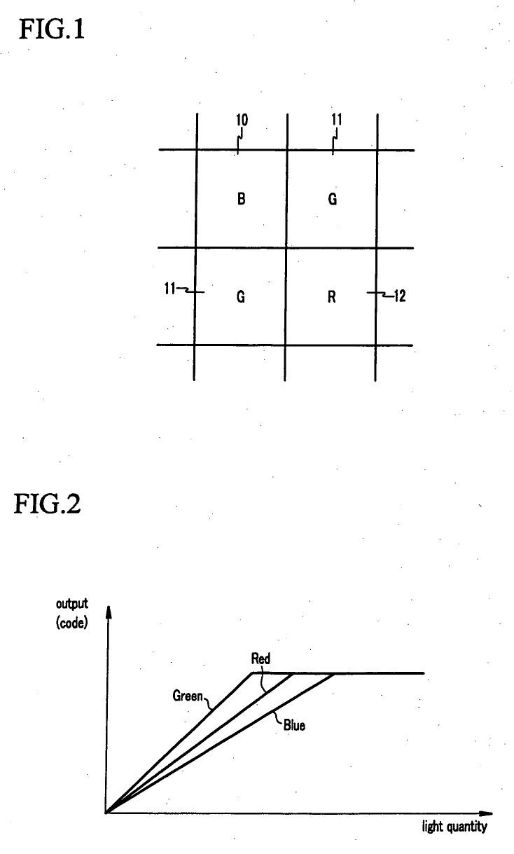

### DETAILED DESCRIPTION OF THE EMBODIMENTS

An exemplary embodiment of the present invention will hereinafter be described in detail with reference to the accompanying drawings.

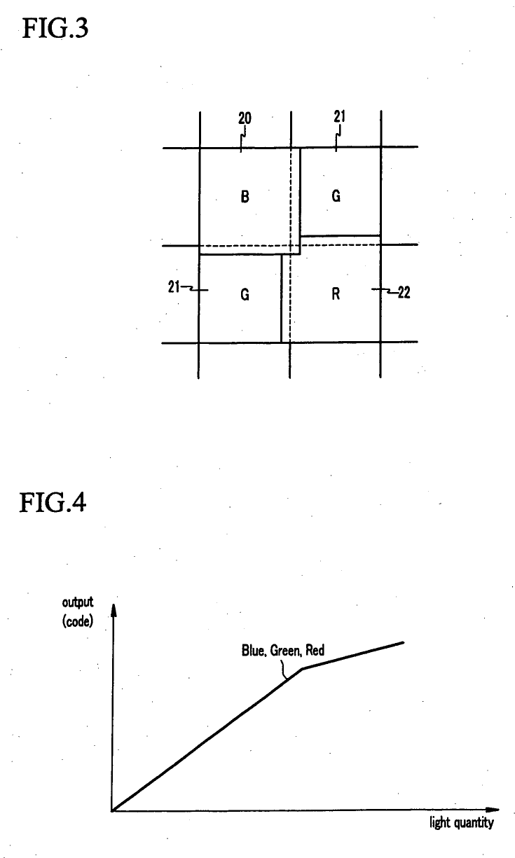

FIG. 3 is a drawing showing a color filter array in a CMOS image sensor according to an exemplary embodiment of the present invention.

The array is similar to a typical bayer pattern, in that there are a blue pixel 20, a pair of green pixels 21 contacting the blue pixel 20 in a longitudinal direction and a transverse direction, and a red pixel 22 disposed in a diagonal direction with the neighboring blue pixel 20. The dotted line in the drawing denotes a status when each pixel has the same size. The blue pixel 20 and the red pixel 22 have a larger size than the green pixel 21.

In more detail, the size of the red pixel 22 and that of the blue pixel 20 may depend on a photosensitivity difference from the green pixel 21. The size of the red pixel 22 may be larger than that of the green pixel 21 by 5-30%, and the size of the blue pixel 20 may be larger than that of the green pixel 21 by 5-40%.

In addition, the size of the blue pixel 20 may be larger than the size of the red pixel 22. In more detail, the size of the blue pixel 20 may depend on a photosensitivity difference between the blue pixel 20 and the red pixel 22. The size of the blue pixel may be larger than that of the red pixel by 5-20%.

Consequently, the relationship of the size of each pixel is blue pixel 20>red pixel 22>green pixel 21.

FIG. 4 is a graph showing photosensitivity of each pixel according to an exemplary embodiment of the present invention.

The x-axis of the graph denotes the light quantity, and the y-axis denotes the output signal. A higher slope indicates the higher photosensitivity. When the relationship of the size of each pixel is blue pixel 20>red pixel 22>green pixel 21 as shown in FIG. 3, the photosensitivity of the blue pixel and the red pixel is enhanced. Accordingly, the photosensitivity of the green, the red, and the blue pixel may be the same, so reproducibility of the colors can be enhanced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A color filter array in a CMOS image sensor wherein sizes of a blue pixel and a red pixel are larger than that of a green pixel.

2. The color filter array in a CMOS image sensor of claim 1 is arranged in a bayer pattern.

3. The color filter array in a CMOS image sensor of claim 1, wherein the size of the blue pixel is larger than the size of the red pixel.

4. The color filter array in a CMOS image sensor of claim 1, wherein the size of the red pixel depends on a photosensitivity difference between the red pixel and the green pixel.

5. The color filter array in a CMOS image sensor of claim 1, wherein the size of the red pixel is larger than that of the green pixel by 5-30%.

6. The color filter array in a CMOS image sensor of claim 1, wherein the size of the blue pixel depends on a photosensitivity difference between the blue pixel and the green pixel.

7. The color filter array in a CMOS image sensor of claim 1, wherein the size of the blue pixel is larger than that of the green pixel by 5-40%.

8. The color filter array in a CMOS image sensor of claim 3, wherein the size of the blue pixel depends on a photosensitivity difference between the blue pixel and the red pixel.

9. The color filter array in a CMOS image sensor of claim 3, wherein the size of the blue pixel is larger than that of the red pixel by 5-20%.
